(19) United States
(12) Patent Application Publication
(10) Pub. No.: US 2011/0315407 A1
(43) Pub. Date: Dec. 29, 2011

(54) SPRINKLER HEAD OF FUSE TYPE

(75) Inventors: Kwang Jin PARK, Seoul (KR); Jae Kil SHIM, Seoul (KR); Sung Ki AHN, Bucheon-si (KR); Suk Jin PARK, Incheon-si (KR); Hyung Jin KIM, Uijeongbu-si (KR); Soo Young KIM, Uijeongbu-si (KR)

(73) Assignee: ASIA UNION CO., LTD., Yangju-si (KR)

(21) Appl. No.: 13/160,798

(22) Filed: Jun. 15, 2011

(30) Foreign Application Priority Data
Jun. 25, 2010 (KR) 10-2010-0060383

(51) Int. Cl. A62C 37/12

(52) U.S. Cl. 169/37

(57) ABSTRACT

The present disclosure relates to a sprinkler head of fuse type, and more particularly, to a sprinkler head of fuse type which may perform an accurate and rapid elastically pressing operation when a fire occurs and particularly prevent any minute opening which may cause a fuse to be cooled due to a leaked fire fighting water and not to function.

### CROSS-REFERENCE TO RELATED APPLICATION

This application claims priority to Korean Patent Application No. 2010-60383, filed on Jun. 25, 2010, and all the benefits accruing therefrom under 35 U.S.C. §119, the contents of which in its entirety are herein incorporated by reference.

### BACKGROUND

1. Field

The present disclosure relates to a sprinkler head of fuse type, and more particularly, to a sprinkler head of fuse type which may perform an accurate and rapid elastically pressing operation when a fire occurs and particularly prevent any minute opening which may cause a fuse to be cooled due to a leaked fire fighting water and not to function.

2. Description of the Related Art

Generally, fire extinguishing equipment is installed in a building against a fire. Among such fire extinguishing equipment, a sprinkler head of fuse type is mostly widely used.

In the sprinkler head of fuse type, a fire fighting water with a predetermined pressure is always filled in a discharging pipe. In this state, a heat sensing plate mounted to the sprinkler head transmits the heat generated by a fire to a fuse included in the sprinkler head of fuse type. The fuse is melted by the transmitted head to perform an elastically pressing operation for opening so that the fire fighting water is injected and dispersed from the discharging pipe installed at the ceiling.

However, in a general sprinkler head of fuse type, if the fuse starts being partially melted by an initial heat generated by a fire, a minute opening operation is performed for injecting a fire fighting water. If the minute opening operation is performed as mentioned above, the fire fighting water may leak out. At this time, the fuse which is being melted is cooled by the leaking fire fighting water so that the fuse is not perfectly melted but cooled again, which causes the sprinkler head of fuse type not to operate.

Accordingly, even though the sprinkler head of fuse type is configured to suitably extinguish an initial-stage fire rapidly, the fire is not extinguished at an initial stage due to the above problem, and the fire becomes bigger.

### SUMMARY

The present disclosure is directed to providing a sprinkler head of fuse type which may perform an accurate and rapid elastically pressing operation when a fire occurs and particularly prevent a fuse from being cooled and not functioning due to a leaked fire fighting water during a minute opening operation.

In one aspect, there is provided a sprinkler head of fuse type, which includes: a housing coupled to a discharging pipe to inject water through a discharging hole formed therein; a frame coupled to a lower end of the housing and having a hooking projection formed at a lower inner periphery thereof; and a valve disposed in the frame so that an upper end thereof closes the discharging hole of the housing, wherein a pin portion protruding from an upper surface of a head portion of a piston pin is inserted into a lower surface of the valve, and a fit-supporting plate and a ball balancer disposed below the fit-supporting plate to close the lower end of the frame are coupled around a screw portion protruding from a lower surface of the head portion of the piston pin, wherein the sprinkler head of fuse type includes: an elastic body disposed between the valve and the piston pin so that an upper end thereof is elastically supported by the valve and a lower end thereof is elastically supported by the piston pin; a ball hooked by the hooking projection of the frame to contact between the fit-supporting plate and the ball balancer; a heat sensing unit disposed at a lower portion of the ball balancer to be coupled to the screw portion of the piston pin so that the heat sensing unit deviates below the frame when a fuse included therein is melted by heat; and a deflector located in the frame and disposed between the valve and the frame to disperse the water injected through the discharging hole while falling down and being hooked by the hooking projection when the heat sensing unit deviates.

The valve may include an upper protrusion and a lower protrusion which respectively protrude on upper and lower surfaces based on the head portion by a predetermined length, and a pin groove may be formed in the lower surface of the lower protrusion so that the pin portion is inserted therein.

The deflector may include: a body having a hollow structure; a rim portion connected to a front end of the body and bent upwards; a sprinkling unit bent upwards and disposed along a circumference with a gap so that water is sprinkled in a radial direction to an upper surface of the rim portion; and a hooking member connected to an upper end of the sprinkling unit and hooked by the hooking projection.

The heat sensing unit may include: a cylinder having a hollow structure; a first heat sensing plate integrated with the cylinder and disposed at a lower end of the cylinder; second and third heat sensing plates disposed at an upper portion of the first heat sensing plate and coupled around the cylinder; a fuse piston inserted into a coupling hole formed in the cylinder and coupled to the screw portion of the piston pin; and a fuse disposed between a flange of the fuse piston and a bending portion formed at a center of the cylinder to form a shaft tube whose inner diameter becomes narrowed in a upward direction so that the fuse contacts the flange and the bending portion.

A spring guide may be coupled between the valve and the head portion of the piston pin so that an upper end of the spring guide is supported by the valve and a lower end of the spring guide is supported by the piston pin while surrounding the elastic body.

A spring guide may be bent downwards and connected to a rim of the valve so that a receiving groove in which the elastic body is inserted is formed.

A spring guide may be integrally connected to an inner front end of a body of the deflector so that a lower end of the spring guide is supported by the head portion of the piston pin while surrounding a lower portion of the elastic body.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a sectional view showing a sprinkler head of fuse type according to an exemplary embodiment of the present disclosure;

FIG. 2a is an enlarged view showing the A portion of FIG. 1;

FIG. 2b is a sectional view showing a valve and a spring guide of FIG. 2a;

FIG. 3 is a sectional view showing operations of the sprinkler head of fuse type according to the exemplary embodiment;

FIG. 4 is a sectional view showing a sprinkler head of fuse type according to another embodiment of the present disclosure;

FIG. 5 is an enlarged view showing the B portion of FIG. 4;

FIG. 6 is a sectional view showing operations of the sprinkler head of fuse type according to the exemplary embodiment;

FIG. 7 is a sectional view showing a sprinkler head of fuse type according to another embodiment of the present disclosure;

FIG. 8 is an enlarged view showing the C portion of FIG. 7; and

FIG. 9 is a sectional view showing operations of the sprinkler head of fuse type according to the exemplary embodiment.

### DETAILED DESCRIPTION

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals denote like elements. The shape, size and regions, and the like, of the drawing may be exaggerated for clarity.

Hereinafter, a sprinkler head of fuse type according to an exemplary embodiment of the present disclosure will be described in detail with reference to the accompanying drawings.

### Embodiment 1

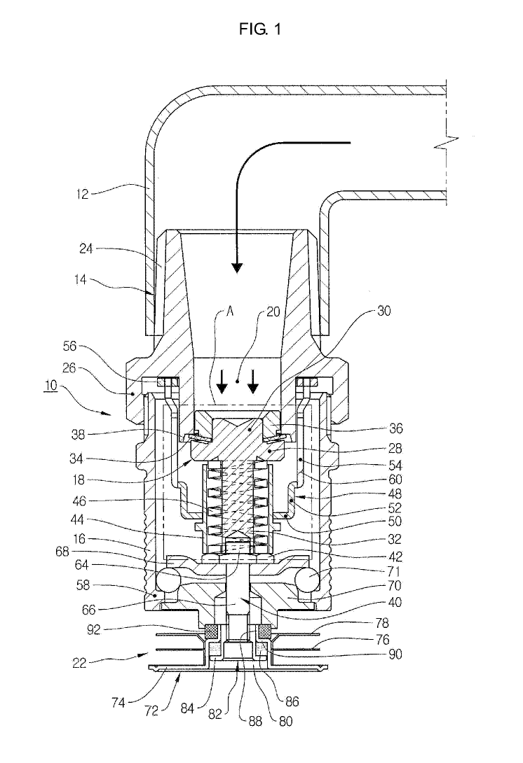

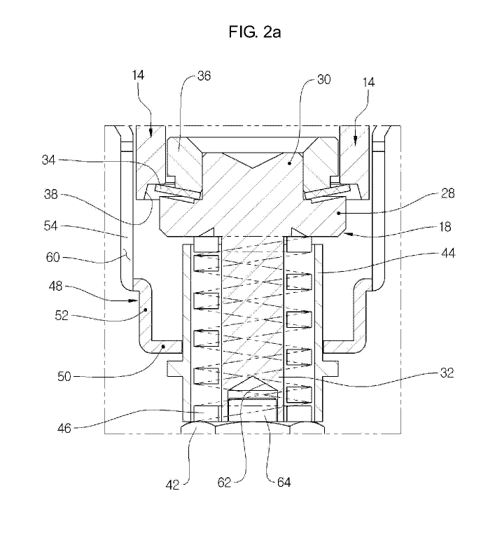

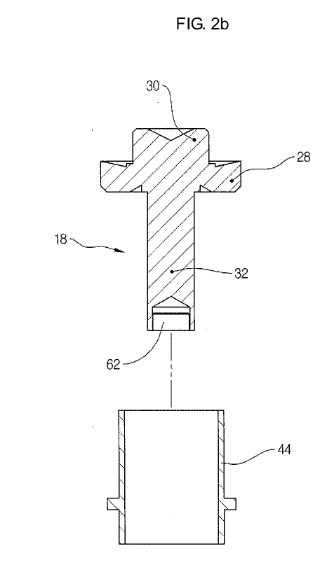

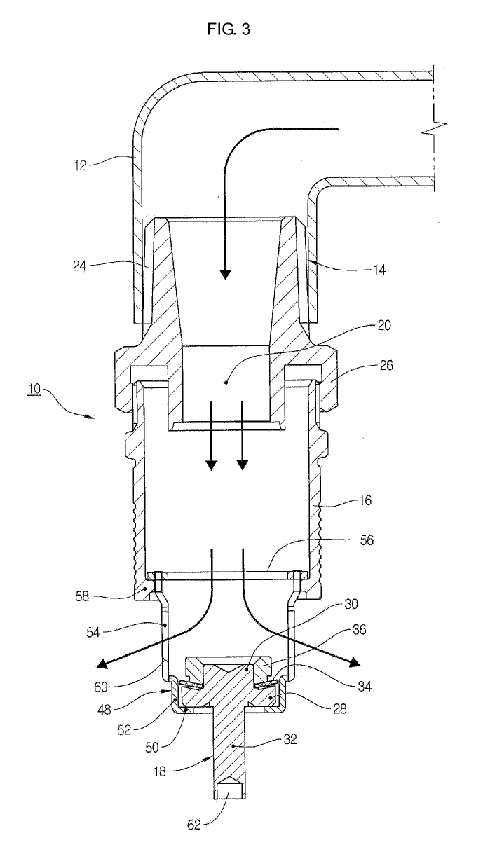

FIG. 1 is a sectional view showing a sprinkler head of fuse type according to an exemplary embodiment of the present disclosure, FIG. 2a is an enlarged view showing the A portion of FIG. 1, FIG. 2b is a sectional view showing a valve and a spring guide of FIG. 2a, and FIG. 3 is a sectional view showing operations of the sprinkler head of fuse type according to the exemplary embodiment.

As shown in FIGS. 1 to 3, a sprinkler head of fuse type 10 includes a housing 14 coupled to a discharging pipe 12 installed at the ceiling, a frame 16 screwed to the lower end of the housing 14, a valve 18 located in the frame 16 to close a discharging hole 20 formed at the inner lower end of the housing 14, and a heat sensing unit 22 mounted to the lower end of the frame 16 and detached downwards from the frame 16 to move the valve 18 downwards when a fuse 86 is melted.

Hereinafter, the sprinkler head of fuse type 10 configured as above will be described in detail.

As shown in the figures, the housing 14 has a cylindrical shape. A male screw 24 is formed on the outer periphery of the housing 14, and a socket 26 is integrally formed at the center of the housing 14. A female screw is formed on the inner periphery of the socket 26.

In addition, the valve 18 is disposed in the housing 14 to close the discharging hole 20, and for closing the discharging hole 20, the valve 18 is configured so that the upper end of the valve 18 closes the discharging hole 20.

In detail, the valve 18 has an upper protrusion 30 and a lower protrusion 32 which respectively protrude on upper and lower surfaces based on a head portion 28 by a length. A pocket ring 34 is coupled through the upper protrusion 30 of the valve 18 configured as above, and a gasket 36 to be coupled to the upper protrusion 30 is configured to press the upper surface of the pocket ring 34.

Therefore, when the valve 18 closes the discharging hole 20 of the housing 14, the gasket 36 closes the discharging hole 20 in a state that the pocket ring 34 of the valve 18 is hooked by a step 38 formed on the lower inner periphery of the housing 14. However, the gasket 36 may not be used, and the upper protrusion 30 of the valve 18 may be directly inserted into the discharging hole 20 to close the discharging hole 20.

A spring guide 44 is disposed at the lower portion of the valve 18 so that the upper and lower ends thereof are respectively supported by a head portion 28 of the valve 18 and a head portion 42 of a piston pin 40, explained later. The spring guide 44 has a hollow structure (see FIGS. 2a and 2b).

In addition, an elastic body 46 serving as an elastically pressing member is disposed between the spring guide 44 and the lower protrusion 32 to surround the outer surface of the lower protrusion32. The elastic body 46 may use a coil-type elastic spring.

The upper end of the elastic body 46 disposed as above is elastically supported by the head portion 28 of the valve 18, and the lower end is elastically supported by the head portion 42 of the piston pin 40, so that an elastically pressing force is applied in upper and lower directions.

Meanwhile, a deflector 48 coupled through the spring guide 44 includes a body 50 having a hollow structure so that the spring guide 44 is coupled through the inner center thereof, a rim portion 52 connected to the front end of the body 50 and bent upwards, and a sprinkling unit 54 bent upwards and disposed along the circumference with a gap so that water is sprinkled in a radial direction to the upper surface of the rim portion 52. In addition, a hooking member 56 having a ring shape is disposed at the upper end of the deflector 48, and the upper end of the sprinkling unit 54 disposed along the circumference is connected and fixed to the lower surface of the hooking member 56.

The hooking member 56 is hooked to a hooking projection 58 of the frame 16, explained later, when moving downwards. In addition, if the sprinkling unit 54 is disposed along the circumference with a gap, a gap is formed between adjacent sprinkling units 54, and this gap functions as a sprinkling hole 60 through which water may be injected and dispersed outwards.

Meanwhile, the piston pin 40 mentioned above is coupled to a pin groove 62 formed in the lower surface of the valve 18. In detail, the piston pin 40 has a pin portion 64 protruding from the head portion 42 and inserted into the pin groove 62 in the upper surface, and a screw portion 66 protruding downwards from the lower surface.

A fit-supporting plate 68 is coupled around the screw portion 66 of the piston pin 40, and a ball balancer 70 located below the fit-supporting plate 68 and disposed to close the lower end of the frame 16 is also coupled around the screw portion 66.

The hooking projection 58 is formed at the inner lower end of the frame 16 along the circumference, and a plurality of balls 71 disposed along the circumference are arranged between the fit-supporting plate 68 and the ball balancer 70 to contact the fit-supporting plate 68 and the ball balancer 70 while being hooked by the hooking projection 58.

The heat sensing unit 22 coupled to the screw portion 66 of the piston pin 40 is disposed at the lower portion of the ball balancer 70. The heat sensing unit 22 includes a cylinder 72 formed to have a hollow structure, a first heat sensing plate 74 integrated with the cylinder 72 and disposed at the lower end thereof, second and third heat sensing plates 76 and 78 coupled around the cylinder 72 while being disposed to the upper portion of the first heat sensing plate 74, a fuse piston 82 inserted into a coupling hole 80 in the cylinder 72 and coupled to the screw portion 66 of the piston pin 40, and a fuse 86 provided to contact the inner surface of the cylinder 72 and a flange 84 of the fuse piston 82.

In detail, the first heat sensing plate 74 is integrally provided to the lower end of the cylinder 72, and a bending portion 90 is formed at the center of the cylinder 72 to form a shaft tube 88 whose inner diameter is gradually decreased in an upward direction.

The fuse 86 is provided along the inner circumference of the cylinder 72 while being disposed between the bending portion 90 and the flange 84 of the fuse piston 82. In addition, an insulator 92 surrounding the outer circumference of the shaft tube 88 is coupled between the shaft tube 88 and the ball balancer 70, and the insulator 92 is made of plastic material to intercept heat transfer between the ball balancer 70 and the cylinder 72 so that the heat may be concentrated to the fuse 86.

Now, operations of the sprinkler head of fuse type 10 configured as above will be described. First, if a fire occurs, the first to third heat sensing plates 74, 76 and 78 and the cylinder 72 are heated by the heat from the fire so that the fuse 86 made of lead is melted.

If the fuse 86 starts being melted, an adhesion between the fuse 86 and the cylinder 72 becomes weakened, and the bending portion 90 of the cylinder 72 gradually moves down toward the flange 84 of the fuse piston 82 due to an elastically pressing force of the elastic body 46 which was compressed as in FIG. 1. In other words, if the fuse 86 is melted, the cylinder 72 moves downwards.

If the cylinder 72 gradually moves down as described above, the insulator 92 and the ball balancer 70 also gradually move downwards. Here, in a general case, the valve and the deflector which close the discharging hole 20 of the housing 14 move downwards along with the cylinder 72 moving downwards.

Accordingly, a fire fighting water leaking through the discharging hole 20 minutely opened cools the melting fuse 86, which causes an operation error. However, in this embodiment, the upper end of the elastic body 46 is elastically supported by the head portion 28 of the valve 18, and the lower end is elastically supported by the head portion 42 of the piston pin 40. Therefore, due to the elastically supporting structure where an elastically pressing force is applied in upper and lower directions, even though the heat sensing unit 22, the fit-supporting plate 68 and the ball balancer 70 move downwards slightly, the valve 18 does not move downwards at all from the discharging hole 20, so long as the balls 71 does not deviate entirely from the hooking projection 58.

For this reason, minute leakage of the fire fighting water is prevented, and the fuse 86 is entirely melted. Accordingly, the process is performed favorably until the balls 71 entirely deviate from the hooking projection 58. For example, at the instant that the balls 71 are driven inwards and entirely deviate from the hooking projection 58, the elastic body 46 is perfectly restored and gives an elastically pressing force so that all of the heat sensing unit 22, the spring guide 44, the elastic body 46, the fit-supporting plate 68, the balls 71, and the ball balancer 70 are entirely separated from the frame 16. Accordingly, the deflector 48 entirely moves downwards together with the valve 18 which was closing the discharging hole 20 of the housing 14 (see FIG. 3).

As described above, if the valve 18 and the deflector 48 entirely move downwards, the hooking member 56 of the deflector 48 is hooked by the hooking projection 58, and the valve 18 is hooked and supported by the body 50 of the deflector 48. Accordingly, the fire fighting water received in the discharge hole 20 is sprinkled in a radial direction through the sprinkling hole 60 between adjacent sprinkling units 54 from the deflector 48 and the discharging hole 20 of the housing 14, for the purpose of extinguishing the fire.

### Embodiment 2

In Embodiment 1 described above, the spring guide has a hollow structure and is individually mounted. However, in Embodiment 2, the spring guide is integrally configured with the valve.

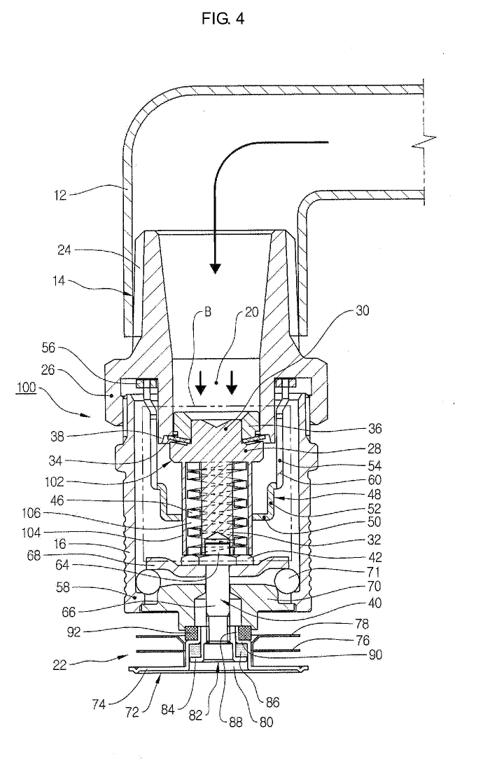

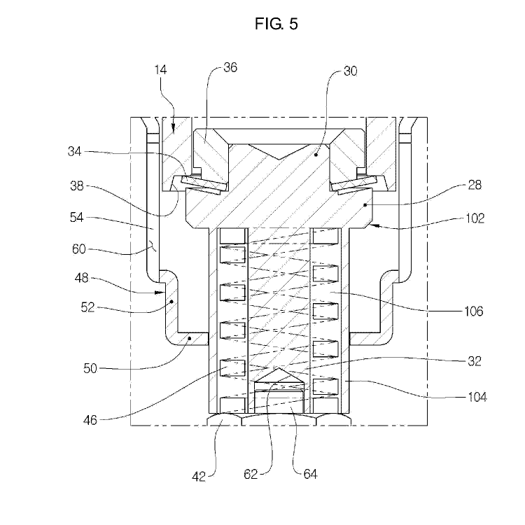

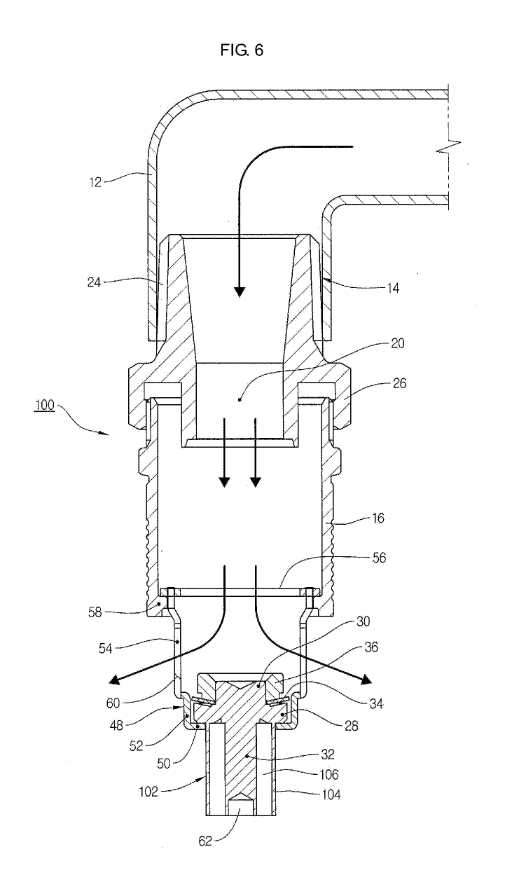

FIG. 4 is a sectional view showing a sprinkler head of fuse type according to another embodiment of the present disclosure, FIG. 5 is an enlarged view showing the B portion of FIG. 4, FIG. 6 is a sectional view showing operations of the sprinkler head of fuse type according to the exemplary embodiment.

As shown in FIGS. 4 to 6, a valve 102 of a sprinkler head of fuse type 100 of this embodiment has an upper protrusion 30 and a lower protrusion 32 which respectively protrude from upper and lower surfaces based on the head portion 28 of a valve 102.

A spring guide 104 is integrally connected to the lower surface of the head portion 28 in a length direction of the lower protrusion 32 and surrounds the lower protrusion 32. In this configuration, a receiving groove 106 for receiving the elastic body 46 is provided between the lower protrusion 32 and the spring guide 104.

Other configurations of Embodiment 2 and operations of the sprinkler head of fuse type 100 when a fire occurs are identical to those of Embodiment 1 described above, and thus they are indicated by the same reference numerals and not described in detail here. For reference, in Embodiment 2, the spring guide 104 is integrated with the head portion 28 of the valve 102, and therefore the spring guide 104 does not deviate during operations (see FIG. 6).

### Embodiment 3

In Embodiment 1 described above, the spring guide has a hollow structure and is individually mounted. In addition, in Embodiment 2, the spring guide is integrally configured with the valve. However, in Embodiment 3, a deflector serving as a spring guide is suggested.

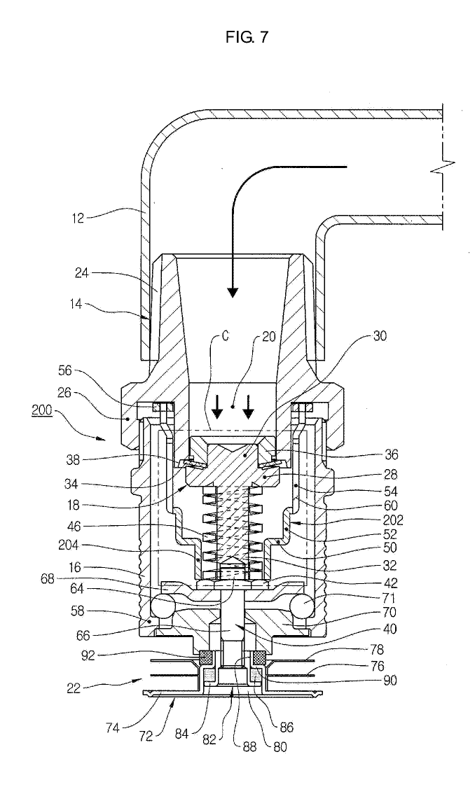

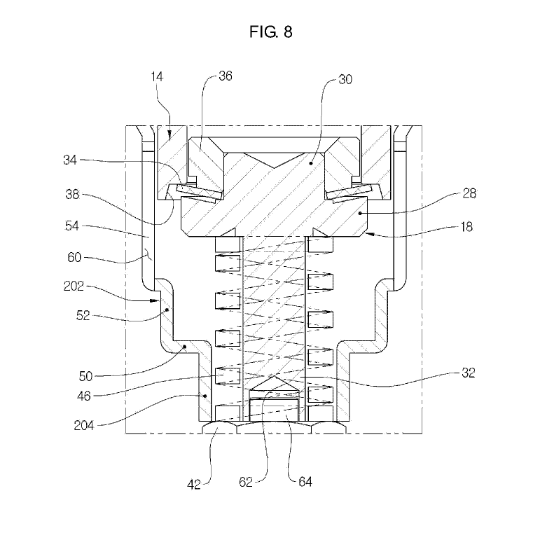

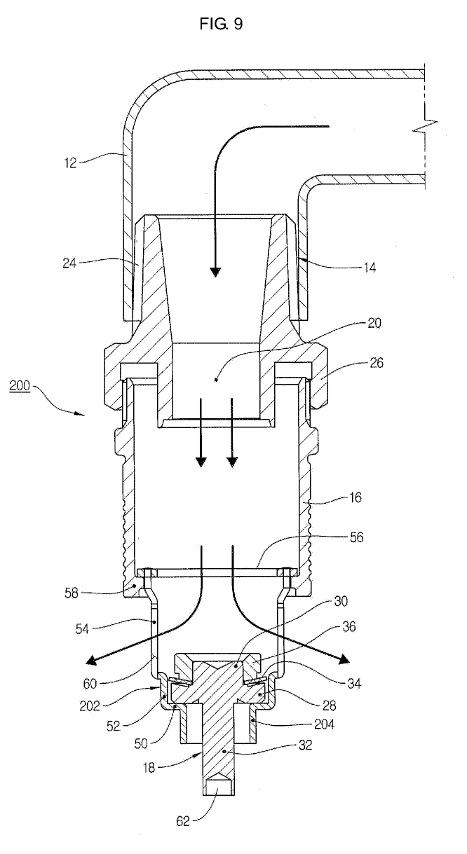

FIG. 7 is a sectional view showing a sprinkler head of fuse type according to another embodiment of the present disclosure, FIG. 8 is an enlarged view showing the C portion of FIG. 7, and FIG. 9 is a sectional view showing operations of the sprinkler head of fuse type according to the exemplary embodiment.

As shown in the figures, a valve 18 of a sprinkler head of fuse type 200 of this embodiment includes an upper protrusion 30 and a lower protrusion 32 which respectively protrude on the upper and lower surfaces based on the head portion 28 of the valve 18 as in Embodiments 1 and 2. In addition, the elastic body 46 is coupled to surround the outer surface of the lower protrusion 32, and the upper end of the elastic body 46 disposed as above is elastically supported by the head portion 28 of the valve 18 and the lower end is elastically supported by the head portion 42 of the piston pin 40.

In the above configuration, in Embodiment 3, a deflector 202 is coupled to the outer side of the elastic body 46 to guide the elastic body 46. In other words, the deflector 202 integrally has a spring guide 204 which is bent downwards from the inner front end of the body 50 with a hollow structure, and the lower end of the spring guide 204 is supported by the head portion 42 of the piston pin 40. Accordingly, in Embodiment 3, the spring guide 204 integrally provided to the deflector 202 surrounds the lower portion of the elastic body 46.

In other words, though the spring guide 44 and 104 of Embodiments 1 and 2 is separately provided to guide the elastic body, the spring guide 204 of Embodiment 3 is formed by bending the body 50 of the deflector 202 to give a guiding function.

Other configurations of Embodiment 3 and operations of the sprinkler head of fuse type 200 when a fire occurs are identical to those of Embodiment 1 described above, and thus they are indicated by the same reference numerals and not described in detail here.

The sprinkler head of fuse type according to the present disclosure prevents a fire fighting water from leaking since a minute opening of a discharging hole is not performed before a heat sensing unit is entirely eliminated due to the structure where an elastic body disposed between a valve and a fit-supporting plate. Therefore, it is possible to solve a problem that the fuse is cooled and does not operate due to a leaked fire fighting water when the fuse is partially melted.

While the exemplary embodiments have been shown and described, it will be understood by those skilled in the art that various changes in form and details may be made thereto without departing from the spirit and scope of the present disclosure as defined by the appended claims.

In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

What is claimed is:

1. A sprinkler head of fuse type, comprising:
a housing coupled to a discharging pipe to inject water through a discharging hole formed therein;
a frame coupled to a lower end of the housing and having a hooking projection formed at a lower inner periphery thereof; and
a valve disposed in the frame so that an upper end thereof closes the discharging hole of the housing,
wherein a pin portion protruding from an upper surface of a head portion of a piston pin is inserted into a lower surface of the valve, and a fit-supporting plate and a ball balancer disposed below the fit-supporting plate to close the lower end of the frame are coupled around a screw portion protruding from a lower surface of the head portion of the piston pin,
wherein the sprinkler head of fuse type comprises:
an elastic body disposed between the valve and the piston pin so that an upper end thereof is elastically supported by the valve and a lower end thereof is elastically supported by the piston pin;
a ball hooked by the hooking projection of the frame to contact between the fit-supporting plate and the ball balancer;
a heat sensing unit disposed at a lower portion of the ball balancer to be coupled to the screw portion of the piston pin so that the heat sensing unit deviates below the frame when a fuse included therein is melted by heat; and
a deflector located in the frame and disposed between the valve and the frame to disperse the water injected through the discharging hole while falling down and being hooked by the hooking projection when the heat sensing unit deviates.

2. The sprinkler head of fuse type according to claim 1, wherein the valve includes an upper protrusion and a lower protrusion which respectively protrude on upper and lower surfaces based on the head portion by a predetermined length, and a pin groove is formed in the lower surface of the lower protrusion so that the pin portion is inserted therein.

3. The sprinkler head of fuse type according to claim 2, wherein the deflector includes:
a body having a hollow structure;
a rim portion connected to a front end of the body and bent upwards;
a sprinkling unit bent upwards and disposed along a circumference with a gap so that water is sprinkled in a radial direction to an upper surface of the rim portion; and
a hooking member connected to an upper end of the sprinkling unit and hooked by the hooking projection.

4. The sprinkler head of fuse type according to claim 3, wherein the heat sensing unit includes:
a cylinder having a hollow structure;
a first heat sensing plate integrated with the cylinder and disposed at a lower end of the cylinder;
second and third heat sensing plates disposed at an upper portion of the first heat sensing plate and coupled around the cylinder;
a fuse piston inserted into a coupling hole formed in the cylinder and coupled to the screw portion of the piston pin; and
a fuse disposed between a flange of the fuse piston and a bending portion formed at a center of the cylinder to form a shaft tube whose inner diameter becomes narrowed in a upward direction so that the fuse contacts the flange and the bending portion.

5. The sprinkler head of fuse type according to claim 1, wherein a spring guide is coupled between the valve and the head portion of the piston pin so that an upper end of the spring guide is supported by the valve and a lower end of the spring guide is supported by the piston pin while surrounding the elastic body.

6. The sprinkler head of fuse type according to claim 1, wherein a spring guide is bent downwards and connected to a rim of the valve so that a receiving groove in which the elastic body is inserted is formed.

7. The sprinkler head of fuse type according to claim 1, wherein a spring guide is integrally connected to an inner front end of a body of the deflector so that a lower end of the spring guide is supported by the head portion of the piston pin while surrounding a lower portion of the elastic body.
